(19) United States
(12) Patent Application Publication
(10) Pub. No.: US 2026/0340665 A1
(43) Pub. Date: Oct. 29, 2026

(54) INFORMATION PROCESSING DEVICE

(71) Applicant: NTT DOCOMO, INC., Tokyo (JP)

(72) Inventors: Tomohiro MIMURA, Tokyo (JP); Shin ISHIGURO, Tokyo (JP); Eri KOIDE, Tokyo (JP)

(73) Assignee: NTT DOCOMO, INC., Tokyo (JP)

(21) Appl. No.: 19/145,377

(22) PCT Filed: Nov. 30, 2023
(86) PCT No.: PCT/JP2023/042953

§ 371 Date: Jul. 2, 2025

(30) Foreign Application Priority Data
Mar. 15, 2023 (JP) 2023-041118

(51) Int. Cl. G06Q 30/0202; G06N 3/092; G06Q 10/04; G06Q 10/20; G06Q 30/0201; G06Q 30/0242; G06Q 30/0251; G06Q 30/0645; G06Q 50/43

(52) U.S. Cl. CPC G06Q 30/0202; G06N 3/092; G06Q 10/04; G06Q 10/20; G06Q 30/0206; G06Q 30/0246; G06Q 30/0265; G06Q 30/0645; G06Q 50/43

(57) ABSTRACT

An information processing device (10) includes an acquisition unit (11) configured to acquire information input to an action value function for estimating a value of an action related to redeployment of a vehicle between a plurality of ports in a shared transportation service in which the vehicle is shared, and a learning and inference unit (12) configured to perform reinforcement learning with respect to the action value function using the information acquired by the acquisition unit (11) to obtain the action value function for selecting an action maximizing a future action value.

### TECHNICAL FIELD

The present disclosure relates to an information processing device that optimizes redeployment of vehicles among a plurality of ports in a shared transportation service. Note that a “port” refers to a space for parking a plurality of shared vehicles (e.g., a bicycle parking lot for parking a plurality of shared electric bicycles), and the plurality of ports is provided in a plurality of locations to provide the shared transportation service.

### BACKGROUND ART

Conventionally, there has been known technology related to a vehicle sharing service which improves the vehicle utilization rate throughout the entire service by collecting vehicles from a port having surplus vehicles among a plurality of ports and deploying the collected vehicles to a port lacking vehicles (see Patent Literature 1).

### CITATION LIST

### Patent Literature

Patent Literature 1: Japanese Unexamined Patent Publication No. 2022-175898

### SUMMARY OF INVENTION

### Technical Problem

The vehicle sharing service is a service provided by a private company, and thus is desirably operated to maximize the reward (profit) for the service as a whole rather than merely replenishing a lack of vehicles at ports appropriately.

However, no technology has been proposed for redeployment of vehicles with a primary focus on maximizing the reward (profit) of the sharing service as a whole.

In consideration of the above circumstances, an object of the disclosure is to optimize redeployment of vehicles so as to maximize a reward (profit) in redeployment of vehicles between a plurality of ports in a shared transportation service.

### Solution to Problem

One type of known machine learning is reinforcement learning, which deals with a problem in which an agent in a certain environment observes a current state and determines an action to be taken in the future based on a policy from state information obtained from observation. The agent obtains a reward from the environment by executing the determined action, and in reinforcement learning, a policy in which a maximum reward is obtained through a series of actions is used for training.

The applicant focuses on the above-mentioned reinforcement learning, and achieved an invention that utilizes a framework of reinforcement learning to optimize vehicle redeployment so that a reward is maximized in reinforcement learning in vehicle redeployment between a plurality of ports in the shared transportation service, which is disclosed in this specification.

An information processing device according to the disclosure includes an acquisition unit configured to acquire information input to an action value function for estimating a value of an action related to redeployment of a vehicle between a plurality of ports in a shared transportation service in which the vehicle is shared, and a learning and inference unit configured to perform reinforcement learning with respect to the action value function using the information acquired by the acquisition unit to obtain the action value function for selecting an action maximizing a future action value.

In the information processing device, the acquisition unit acquires information input to an action value function for estimating a value of an action related to redeployment of a vehicle between a plurality of ports in a shared transportation service. Examples of the information will be described in detail in the embodiment of the invention, but “acquire” here broadly includes not only obtaining information but also computing information using a predetermined formula, etc. The learning and inference unit performs reinforcement learning with respect to the action value function using the information acquired by the acquisition unit to obtain an action value function for selecting an action that maximizes a future action value. In this way, through reinforcement learning, the action value function is used for training to obtain an action value function for selecting an action that maximizes a future action value.

Since a value of an action related to redeployment of vehicles between a plurality of ports is estimated based on such an action value function, and a control operation is performed so that an action that maximizes a value of a future action is selected, it is possible to optimize redeployment of vehicles to maximize a reward in reinforcement learning in redeployment of vehicles between a plurality of ports in a shared transportation service.

### Advantageous Effects of Invention

According to the disclosure, it is possible to optimize redeployment of vehicles to maximize a reward in reinforcement learning in redeployment of vehicles between a plurality of ports in a shared transportation service.

### BRIEF DESCRIPTION OF DRAWINGS

FIG. 1 is a functional block diagram of an information processing device in an embodiment of the invention.

FIG. 2 is a diagram for describing an overview of reinforcement learning.

FIG. 3 is a diagram illustrating an example of state information, etc. when this case is applied to reinforcement learning.

FIG. 4 is a diagram for describing a discounted cumulative reward

FIG. 5 is a diagram for describing a state value function.

FIG. 6 is a diagram for describing training using the state value function.

FIG. 7 is a diagram for describing an example of computing a reward in reinforcement learning.

FIG. 8 is a diagram for describing computation of the average number of times of usage by being placed at a port.

FIG. 9 is a diagram illustrating an example of information used in the computation of the average number of times of usage by being placed at the port.

FIG. 10 is a diagram for describing the computation of the average number of impressions of a bicycle.

FIG. 11 is a diagram illustrating an example of information used in the computation of the average number of impressions of the bicycle.

FIG. 12 is a flow diagram illustrating a learning stage process.

FIG. 13 is a flow diagram illustrating details of processing of step S4 of FIG. 12.

FIG. 14 is a flow diagram illustrating an inference stage process.

FIG. 15 is a diagram illustrating a hardware configuration example of the information processing device.

### DESCRIPTION OF EMBODIMENTS

Hereinafter, an embodiment of an information processing device that optimizes vehicle redeployment among a plurality of ports in a shared transportation service will be described with reference to the drawings.

### (Configuration of Information Processing Device)

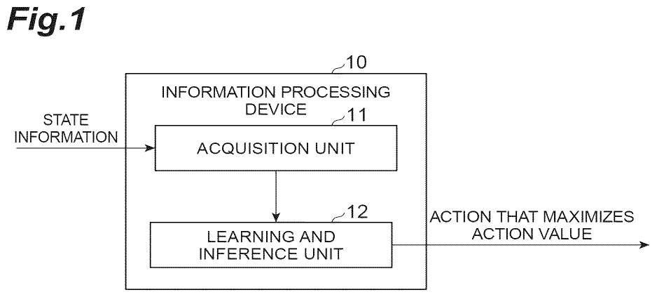

As illustrated in FIG. 1, an information processing device 10 includes an acquisition unit 11 and a learning and inference unit 12. Among these units, the acquisition unit 11 is a functional unit having a function of acquiring information input to an action value function that estimates a value of an action related to vehicle redeployment between a plurality of ports in a shared transportation service in which vehicles are shared. The learning and inference unit 12 is a functional unit having a function of performing reinforcement learning with respect to the action value function using the information acquired by the acquisition unit 11 to obtain an action value function that selects an action whose future value will become the highest.

The vehicles shared in the shared transportation service in this embodiment are vehicles that can be restarted by replacing batteries and have advertisements placed on bodies, and examples thereof include rental electric bicycles, rental electric kick scooters, rental motorbikes, rental cars, etc. Hereinafter, a service of sharing a “rental electric bicycle” among the above-mentioned vehicles will be described as an example, and “rental electric bicycle” will be abbreviated to “bicycle”.

In addition, to provide the shared transportation service, a plurality of ports (here, bicycle parking lots for parking a plurality of shared electric bicycles) is provided at a plurality of locations, and a plurality of bicycles is parted at each port. As actions related to bicycle redeployment, a service staff member uses a bicycle transport truck (hereinafter referred to as a “redeployment truck”) to “deploy” a bicycle at a port, “collect” the bicycle from the port, and “replace” a battery installed in the bicycle.

Assuming the shared transportation service as described above, the learning and inference unit 12 computes (a) a deployment evaluation value related to deployment, (b) a collection evaluation value related to collection, and (c) a battery replacement evaluation value related to battery replacement for each port using a computation formula described later, while considering an impression, which is the number of times an advertisement is viewable, as an element of a “reward” included in a value of an action, and performs reinforcement learning based on (a) the placement evaluation value, (b) the collection evaluation value, and (c) the battery replacement evaluation value obtained for all ports.

In addition, in an “action inference stage” after reinforcement learning, the learning and inference unit 12 has a function of acquiring an action value when each of various actions is performed in a current state by substituting current state information acquired by the acquisition unit 11 into an action value function obtained by reinforcement learning, and selecting an action that maximizes the obtained action value as an action to be taken.

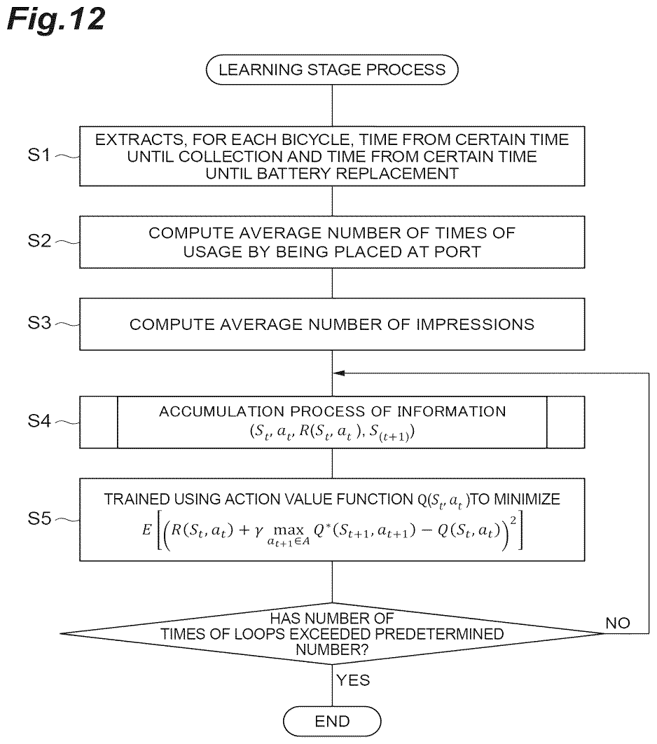

A “learning stage process” related to the above-mentioned reinforcement learning and an “inference stage process” related to inference of an action will be described later with reference to FIGS. 12 to 14.

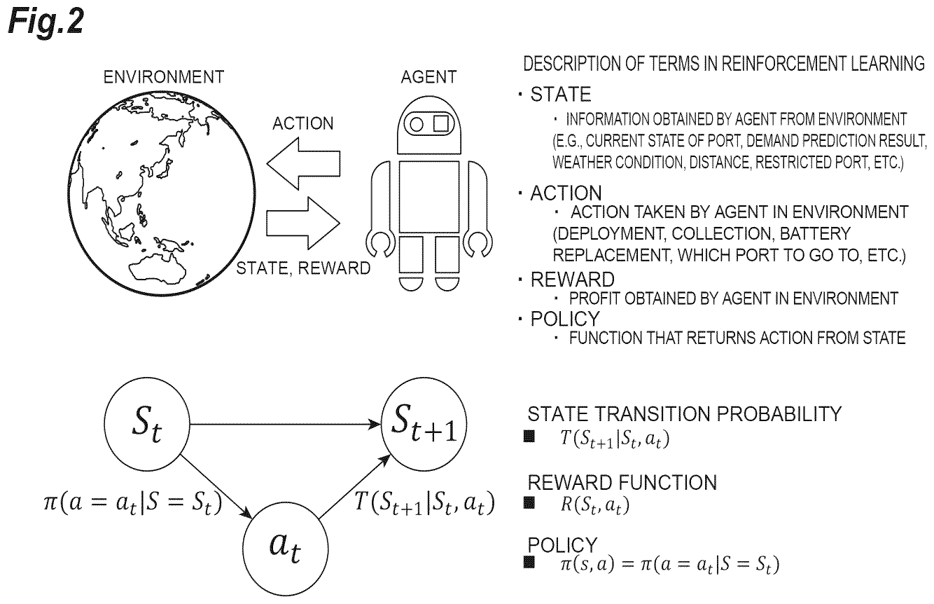

### (Overview of Reinforcement Learning and Supplementary Description of Learning Method (FIGS. 2 to 6))

As mentioned above, one type of known machine learning is reinforcement learning, which deals with a problem in which an agent in a certain environment observes a current state and determines an action to be taken in the future based on a policy from state information obtained from observation. The agent obtains a reward from the environment by executing the determined action, and in reinforcement learning, a policy in which a maximum reward is obtained through a series of actions is used for training.

The applicant focuses on the above-mentioned reinforcement learning, and the following discloses technology that utilizes a framework of reinforcement learning to optimize vehicle redeployment so that a reward is maximized in reinforcement learning in vehicle redeployment between a plurality of ports in the shared transportation service.

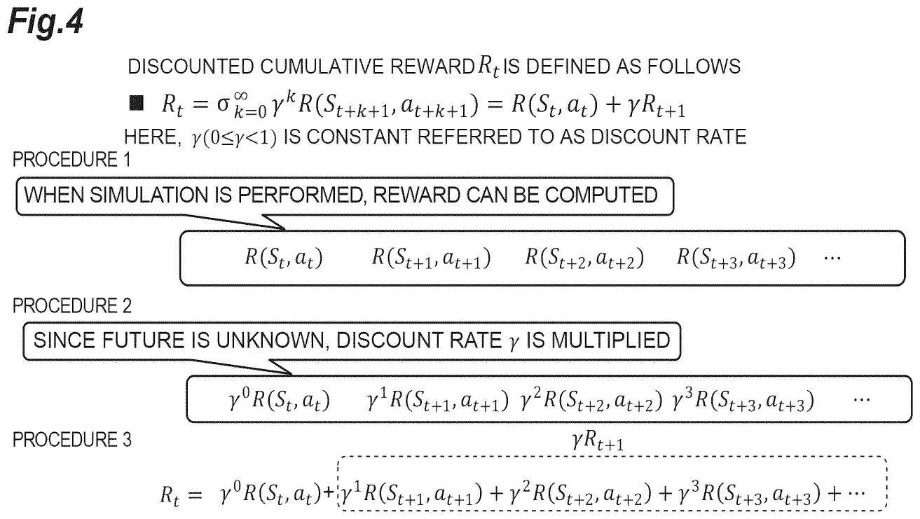

As illustrated in FIG. 2, in reinforcement learning, a “state” is information obtained by the agent from the environment, such as a current port state, a demand prediction result, weather condition, distance, and a restricted port. An “action” is an action taken by the agent in the environment, and examples thereof include deployment, collection, battery replacement, and which port to go to. A “reward” is a profit obtained by the agent in the environment. Here, examples thereof include “discounted cumulative reward Rₜ” described later with reference to FIG. 4. A “policy” is a function π that returns an action from a state.

As illustrated in a lower part of FIG. 2, when a state Sₜ obtained from the environment is input to the function π related to the policy, an action aₜ is returned. Therefore, when the agent performs the action aₜ in the state Sₜ, a state Sₜ₊₁ is obtained. A probability of transitioning to the state Sₜ₊₁ (state transition probability) is denoted as T (Sₜ₊₁|Sₜ, aₜ), and a reward when the agent performs the action aₜ in the state Sₜ is denoted as a reward function R(Sₜ, aₜ).

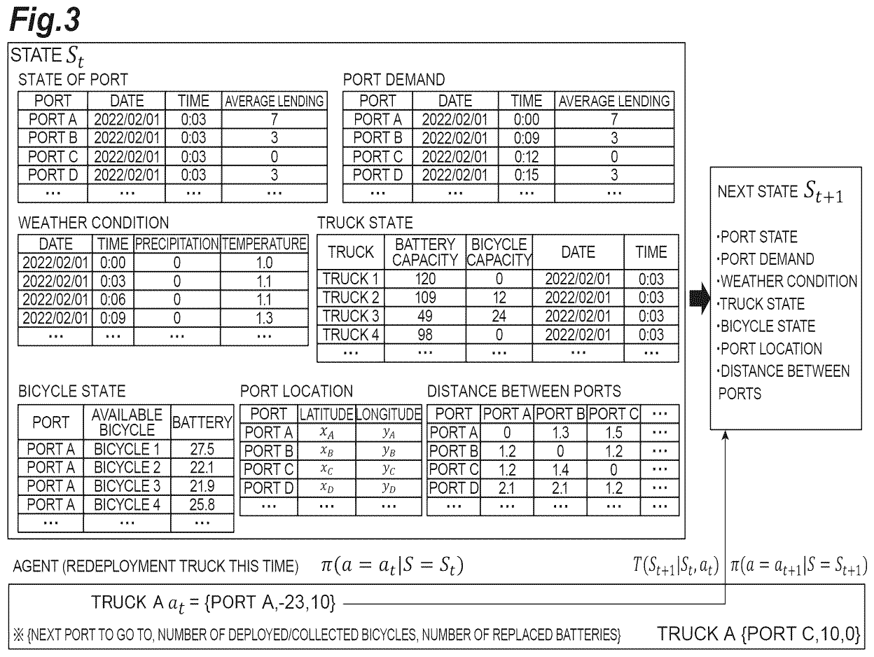

As illustrated in FIG. 3, information examples for the states Sₜ and Sₜ₊₁ include a port state, port demand, weather, a truck state, a bicycle state, a port location, a distance between ports, etc. By inputting the state Sₜ to the function π related to the policy, actions such as a “port A” as a “next port to go to”, “−23” as “the number of deployed/collected bicycles”, and “10” as “the number of replaced batteries” are returned as the action aₜ with regard to a “truck A” as an agent. Note that, when the number of deployed/collected bicycles is a positive value, this means that bicycles corresponding to the number are deployed, and when the number of deployed/collected bicycles is a negative value, this means that bicycles corresponding to the number are collected. Therefore, the above example means actions of collecting 23 bicycles and replacing 10 batteries at the next port A to go to. The state Sₜ₊₁ is obtained by the agent (truck A) performing the action aₜ in the state Sₜ, and when the state Sₜ₊₁ is input to the function π related to the policy, for example, actions such as a “port C” as a “next port to go to”, “10” as “the number of deployed/collected bicycles”, and “0” as “the number of replaced batteries” are returned as the action aₜ₊₁ with regard to the “truck A” as an agent. These actions mean that ten bicycles are deployed at the next port C to go to and battery replacement is not performed (replacement is not required).

As illustrated in FIG. 4, in this case, a “reward” in reinforcement learning is defined as “discounted cumulative reward Rt” as in the following Expression (1).

$${R}_{t} = {\sum }_{k = 0}^{∞} {γ}^{k} R ( {S}_{t + k + 1} , {a}_{t + k + 1} ) = R ( {S}_{t} , {a}_{t} ) + γ {R}_{t + 1} \qquad ( 1 )$$

Here, γ (0≤γ<1) is a constant referred to as a discount rate. In other words, even though it is necessary to take a future reward into account, in reality, the future reward is unknown at the present time, and thus the discount rate γ is assumed. In this instance, the discount rate γ is multiplied for each generation toward the future as follows. In other words, a reward R(Sₜ₊₁, aₜ₊₁) after one generation is γ¹R(Sₜ₊₁, aₜ₊₁), a reward R(Sₜ₊₂, aₜ₊₂) after two generations is γ²R(Sₜ+2, aₜ₊₂), and a reward R(Sₜ₊₃, aₜ₊₃) after three generations is γ³R(Sₜ₊3, aₜ₊₃).

Here,
discounted cumulative reward Rₜ=γ¹R(Sₜ₊₁, aₜ₊₁)+γ¹R(Sₜ₊₁, aₜ₊₁)+γ¹R(Sₜ₊₁, aₜ₊₁)+γ¹R(Sₜ₊₁, aₜ₊₁)+ . . . , and
a part enclosed by a dashed line in a bottom row of FIG. 4 corresponds to yRt+1, leading to the above Expression (1).

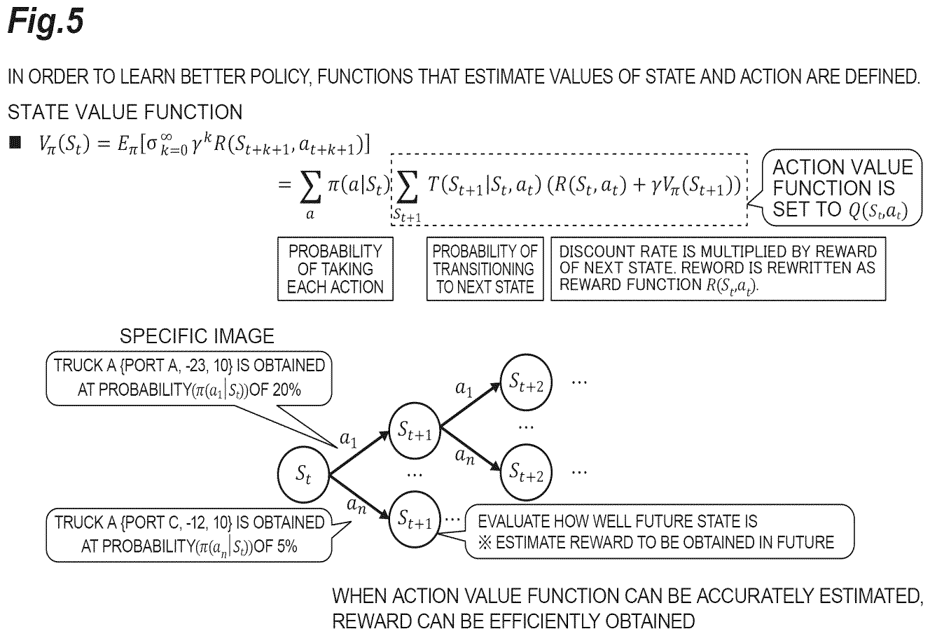

In addition, as illustrated in FIG. 5, in reinforcement learning, in order to learn a better policy, a state value function that estimates a value of a state and an action value function that estimates a value of an action are defined. Here, a “state value function V_{π}(Sₜ)” is a function that represents how much discounted reward can be obtained in the future starting from the state Sₜ according to the policy π. The “action value function” is a function that represents how much discounted reward can be obtained in the future when a certain action is taken from the state Sₜ, and constitutes part of the state value function.

$$\begin{matrix}{V}_{π} ( {S}_{t} ) = {E}_{π} [ {\sum }_{k = 0}^{∞} {γ}^{k} R ( {S}_{t + k + 1} , {a}_{t + k + 1} ) ] \\ = {\sum }_{a} π ( a \vert {S}_{t} ) {\sum }_{{S}_{t + 1}} T ( {S}_{t + 1} \vert {S}_{t} , {a}_{t} ) ( R ( {S}_{t} , {a}_{t} ) + γ {V}_{π} ( {S}_{t + 1} ) )\end{matrix} \qquad ( 2 )$$

A latter part of a second stage of the above Expression (2) (part surrounded by a dashed line in FIG. 5) corresponds to an action value function Q (Sₜ, aₜ). In this instance, when the action value function can be accurately estimated, a reward can be efficiently obtained.

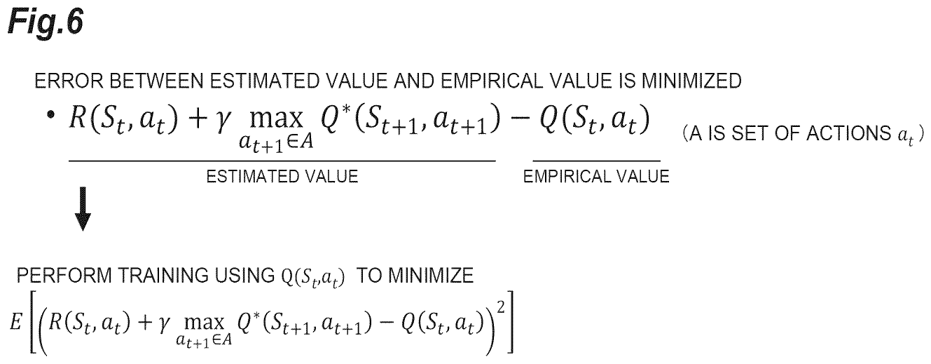

Therefore, as illustrated in FIG. 6, the action value function Q (Sₜ, aₜ) is used for training to minimize an error between an estimated value and an empirical value. The error is described below. “A” means a set of actions aₜ.

$$R ( {S}_{t} , {a}_{t} ) + γ {max}_{{a}_{t + 1} ∈ A} {Q}^{*} ( {S}_{t + 1} , {a}_{t + 1} ) - Q ( {S}_{t} , {a}_{t} ) \qquad ( 3 )$$

Specifically, the action value function Q (Sₜ, aₜ) is used for training to minimize E.

$$E [ ( R ( {S}_{t} , {a}_{t} ) + γ {max}_{{a}_{t + 1} ∈ A} Q * ( {S}_{t + 1} , {a}_{t + 1} ) - {Q ( {S}_{t} , {a}_{t} )}^{2} ] \qquad ( 4 )$$

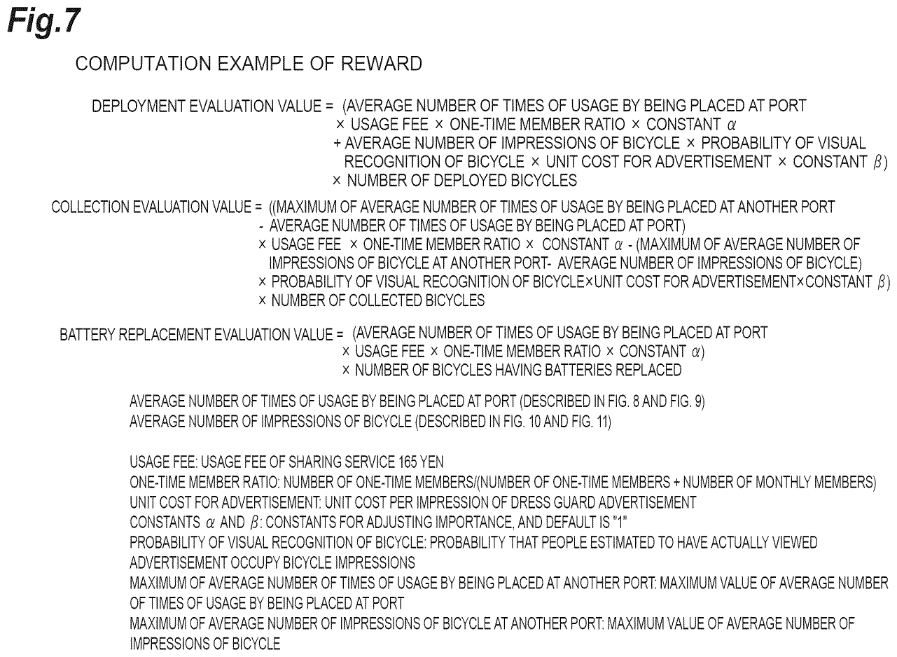

### (Description of Computation Examples of Reward in Reinforcement Learning (FIGS. 7 to 11))

As described above, the learning and inference unit 12 computes (a) a deployment evaluation value related to deployment, (b) a collection evaluation value related to collection, and (c) a battery replacement evaluation value related to battery replacement for each port using a computation formula described later, while considering an impression, which is the number of times an advertisement is viewable, as one element included in a value of an action, and performs reinforcement learning based on (a) the placement evaluation value, (b) the collection evaluation value, and (c) the battery replacement evaluation value obtained for all ports. Hereinafter, a description will be given of computation of (a) the placement evaluation value, (b) the collection evaluation value, and (c) the battery replacement evaluation value with reference to FIGS. 7 to 11.

As illustrated in FIG. 7, (a) the placement evaluation value is computed according to Expression (5)

deployment evaluation value=(average number of times of usage by being placed at port×usage fee×one-time member ratio×constant α×average number of impressions of bicycle×probability of visual recognition of bicycle×unit cost for advertisement×constant β)×number of deployed bicycles (5)

As illustrated in FIG. 7, (b) the collection evaluation value is computed according to Expression (6)

collection evaluation value=((maximum of average number of times of usage by being placed at another port−average number of times of usage by being placed at port)×usage fee×one-time member ratio×constant α−(maximum of average number of impressions of bicycle at another port-average number of impressions of bicycle)×probability of visual recognition of bicycle×unit cost for advertisement×constant β)×number of collected bicycles (6)

As illustrated in FIG. 7, (c) the battery replacement evaluation value is computed according to Expression (7)

battery replacement evaluation value=(average number of times of usage by being placed at port×usage fee×one-time member ratio×constant α)×number of bicycles having batteries replaced (7)

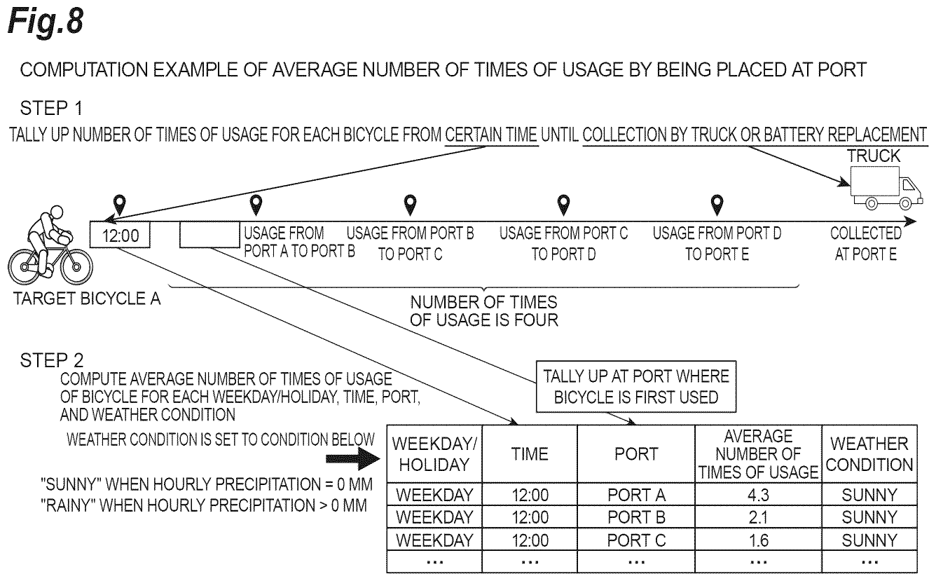

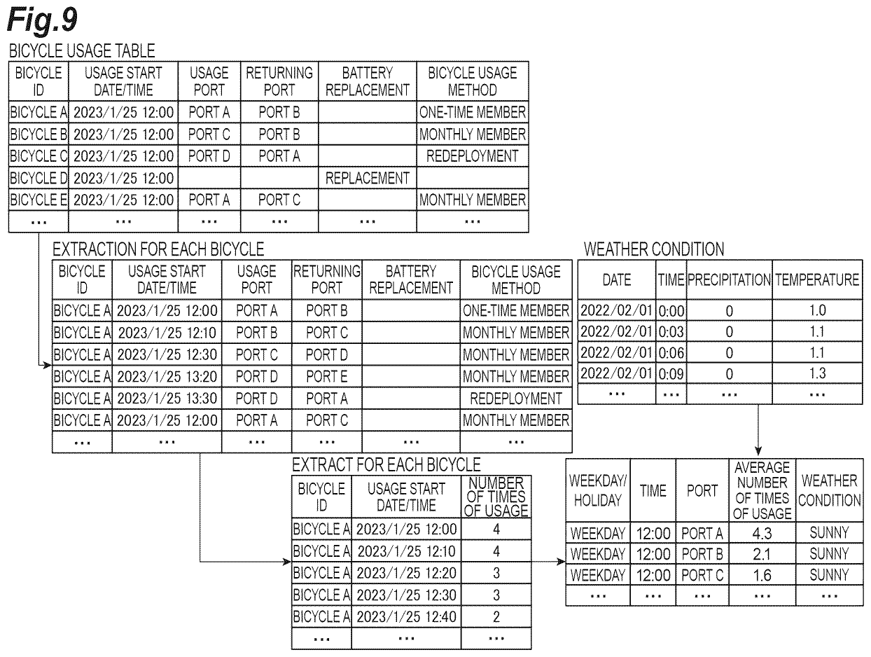

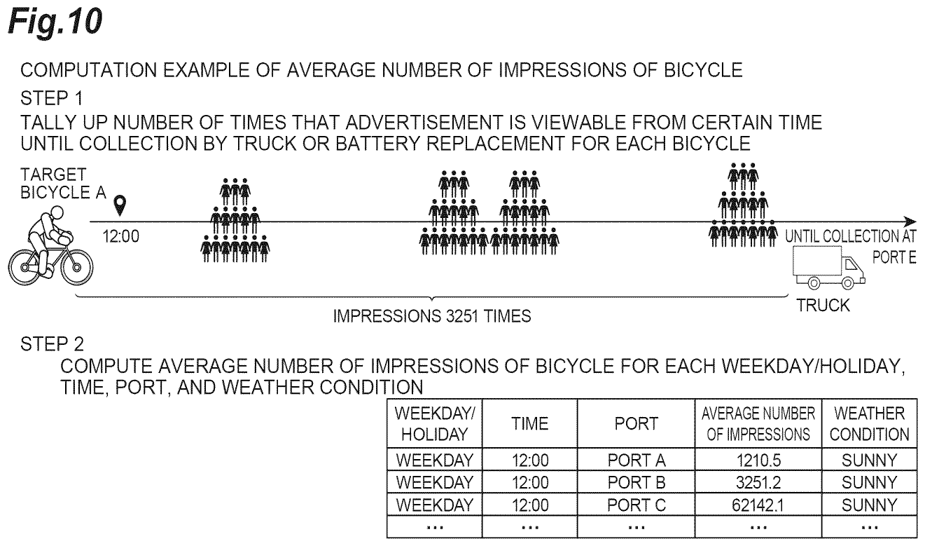

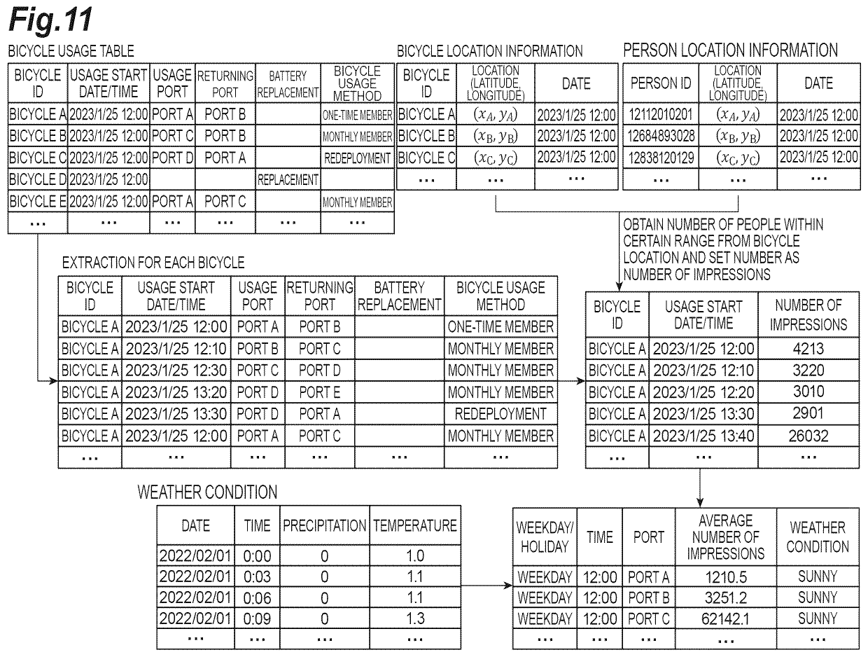

Next, an overview of each of elements of Expressions (5) to (7) will be provided.
“Average number of times of usage by being placed at port” will be described later with reference to FIG. 8 and FIG. 9.
“Average number of impressions of bicycle” will be described later with reference to FIG. 10 and FIG. 11.
“Usage fee” is a usage fee for an electric bicycle sharing service, and is, for example, 165 yen.
“One-time member ratio” is a ratio of the number of one-time members to the total number of members. Here, two types of members, namely, a monthly member who pays a fixed monthly amount and a one-time member who pays the usage fee each time and uses the service, are assumed as members, and the one-time member ratio is computed by the number of one-time members/(the number of one-time members+the number of monthly members).
“Unit cost for advertisement” is a unit cost per impression of a dress guard advertisement placed on a body of a shared bicycle.
“Constants α and β” are constants for adjusting the importance, which are determined by taking into account a profit obtained by deploying a bicycle at a port and a profit obtained by a dress guard advertisement, and the default is set to “1”.
“Probability of visual recognition of a bicycle” is a probability that people estimated to have actually viewed an advertisement occupy bicycle impressions.
“Maximum of average number of times of usage by being placed at another port” is a maximum value of “average number of times of usage by being placed at port”.
“Maximum of average number of impressions of bicycle at another port” is a maximum value of “average number of impressions of bicycle”.
“Number of deployed bicycles”, “number of collected bicycles”, and “number of bicycles having batteries replaced” are information included in the action a returned by inputting the state S to the policy π.

As illustrated in FIG. 8, “average number of times of usage by being placed at port” is obtained through a procedure of tallying up the number of times of usage for each bicycle from a certain time (reference time) until collection by a truck or battery replacement (step 1), and then computing the average number of times of usage of the bicycle for each weekday/holiday, time, port, and weather condition (step 2). FIG. 8 illustrates a situation in which, after a reference time 12:00, a bicycle A is used from a port A to a port B, then used from the port B to a port C, then used from the port C to a port D, further used from the port D to a port E, and then collected by a truck at the port E. In this situation, the bicycle A is used four times until being collected by the truck without replacement of a battery after the reference time 12:00, and thus in step 1, the bicycle A is tallied as “used four times”. This type of tally is performed for each bicycle. Furthermore, in step 2, as illustrated in a table on the lower right of FIG. 8, the average number of times of usage of the bicycle is computed for each weekday/holiday, time, port, and weather condition. In this instance, for example, the weather condition is considered to be “sunny” when hourly precipitation=0 mm, and is considered to be “rainy” when hourly precipitation>0 mm. In addition, the “port” in the tally table is considered to be a port where the bicycle is first used after the reference time.

More specifically, as illustrated in FIG. 9, the acquisition unit 11 extracts usage history information for each bicycle from a usage table that stores bicycle usage history information, and obtains a usage start date/time (reference time) and the number of times of usage from the usage history information for the bicycle A, which is a computation target, as illustrated in FIG. 8. Then, the acquisition unit 11 determines the weather condition at that time by looking up weather condition information at the usage start date/time, and computes the average number of times of usage of the bicycle for each weekday/holiday, time, port, and weather condition as illustrated in a table on the lower right of FIG. 9.

As illustrated in FIG. 10, “average number of impressions of bicycle” is obtained through a procedure of tallying up the number of times that an advertisement is viewable from a certain time (reference time) until collection by the truck or battery replacement for each bicycle according to an outline below (step 1), and computing the average number of impressions of the bicycle for each weekday/holiday, time, port, and weather condition (step 2). Note that determination of the weather condition is similar to that of the above-described example of the FIG. 8.

More specifically, as illustrated in FIG. 11, the acquisition unit 11 extracts usage history information for each bicycle from a usage table that stores bicycle usage history information. In addition, the acquisition unit 11 extracts people present within a certain range from a location of a target bicycle (bicycle A in FIG. 11) based on bicycle location information and person location information, and tallies up the number of people to set the obtained number of people as the number of impressions of the target bicycle A (the number of times that an advertisement is viewable). The number of impressions is computed for each usage history of the bicycle and merged with the usage history information for each bicycle extracted above to obtain the number of impressions for each bicycle for each usage start date/time (reference time). Then, the acquisition unit 11 determines the weather condition at that time by looking up weather condition information at the usage start date/time (reference time), and computes the average number of times of usage of the bicycle for each weekday/holiday, time, port, and weather condition as illustrated in a table on the lower right of FIG. 11.

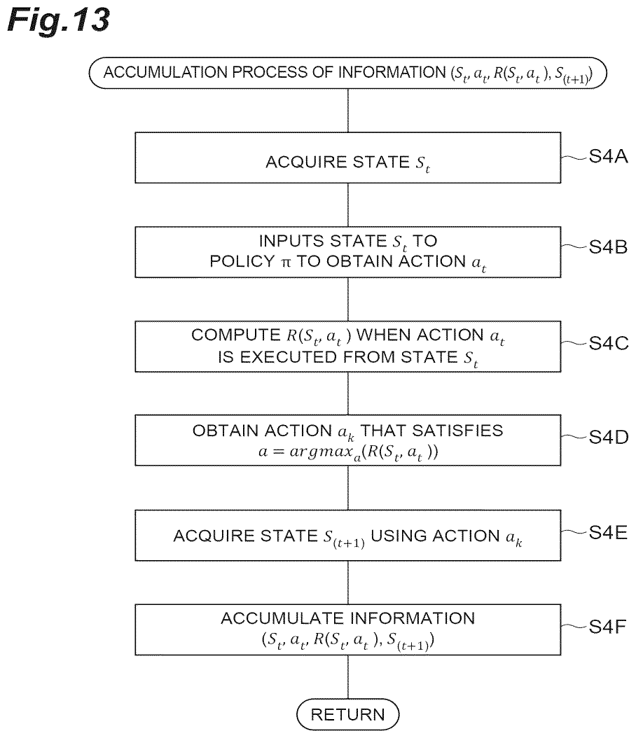

### (Description of Learning Stage Process (FIG. 12 to FIG. 13)

The “learning stage process” and the “inference stage process” executed in the information processing device 10 will be described below in order.

FIG. 12 illustrates a flow of the learning stage process. First, the acquisition unit 11 extracts, for each bicycle, a time from a certain time until collection and a time from a certain time until battery replacement from the bicycle usage tables of FIG. 9 and FIG. 11 (step S1). For example, the “certain time” may be selected from a plurality of candidates for the reference time determined in advance. Next, the acquisition unit 11 computes the average number of times of usage by being placed at a port according to the procedure described above with reference to FIG. 8 and FIG. 9 (step S2). In this way, as in the table on the lower right of FIG. 9, the average number of times of usage of the bicycle is computed for each weekday/holiday, time, port, and weather condition. Furthermore, the acquisition unit 11 computes the average number of impressions according to the procedure described above with reference to FIG. 10 and FIG. 11 (step S3). In this way, the average number of impressions of the bicycle is computed for each weekday/holiday, time, port, and weather condition as illustrated in the table on the lower right of FIG. 11.

Next, the learning and inference unit 12 performs an accumulation process of information (Sₜ, aₜ, R(Sₜ, aₜ), Sₜ₊₁) as illustrated in FIG. 13 (step S4). First, the learning and inference unit 12 acquires the state Sₜ acquired by the acquisition unit 11 (step S4A of FIG. 13), and inputs the acquired state Sₜ to the policy π to obtain the action aₜ (step S4B). In this instance, in reality, a plurality of possible actions a₁, a₂, . . . , aₙ is obtained. Then, the learning and inference unit 12 computes a discounted cumulative reward R(Sₜ, aₜ) when each of the actions at (a₁, a₂, . . . , aₙ) is executed from the state Sₜ using the expression of the discounted cumulative reward Rt (step S4C). In this instance, specifically, the “deployment evaluation value”, the “collection evaluation value”, and the “battery replacement evaluation value” described using FIG. 7 to FIG. 11 are computed for each bicycle, and the discounted cumulative reward R(Sₜ, aₜ) is computed from the above three evaluation values for all bicycles. Then, the learning and inference unit 12 obtains an action aₖ that maximizes the computed discounted cumulative reward (step S4D). That is, in step S4D, among the plurality of possible actions a₁, a₂, . . . , aₙ, the action aₖ that satisfies the following expression is obtained.

a=argmax_{α}(R(Sₜ,aₜ))

Furthermore, the learning and inference unit 12 performs a simulation using the action aₖ obtained in step S4D to acquire a next state Sₜ₊₁ (step S4E), and accumulates information (Sₜ, aₜ, R(Sₜ, aₜ), Sₜ₊₁) including the state Sₜ, the action aₜ (i.e., the action aₖ that maximizes the discounted cumulative reward), the reward R(Sₜ, aₜ) (i.e., the discounted cumulative reward when the action aₖ is executed from the state Sₜ), and the next state Sₜ₊₁ obtained in this manner (step S4F).

Returning to FIG. 12, the learning and inference unit 12 is trained using the action value function Q (Sₜ, aₜ) to minimize E (step S5).

$$E [ ( R ( {S}_{t} , {a}_{t} ) + γ {max}_{{a}_{t + 1} ∈ A} Q * ( {S}_{t + 1} , {a}_{t + 1} ) - {Q ( {S}_{t} , {a}_{t} )}^{2} ]$$

Thereafter, the learning and inference unit 12 is trained using the action value function Q (Sₜ, aₜ) by repeating processing of steps S4 and S5 a predetermined number of times of loops, and ends processing of FIG. 12 after repeating the number of times of loops.

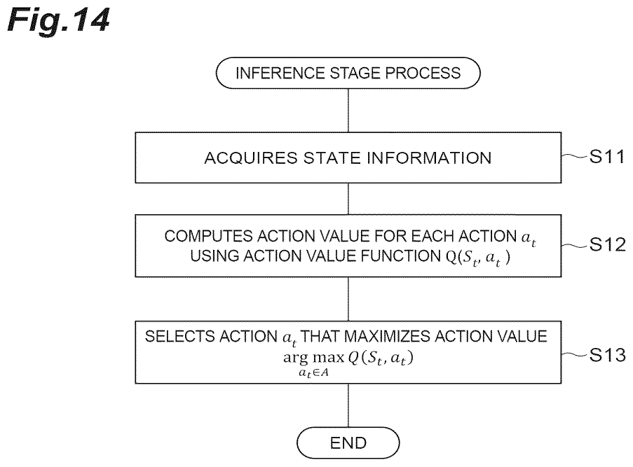

### (Description of Inference Stage Process (FIG. 14))

FIG. 14 illustrates a flow of the inference stage process. First, the acquisition unit 11 acquires the state information Sₜ (step S11) similarly to the learning stage process described above, and the learning and inference unit 12 computes an action value for each action aₜ using the action value function Q (Sₜ, aₜ) obtained by training (step S12). Then, the learning and inference unit 12 selects the action aₜ that maximizes the action value (step S13). In this way, the action that maximizes a value of a future action is selected.

$${arg max}_{{a}_{t} ∈ A} Q ( {S}_{t} , {a}_{t} )$$

### Effects of the Embodiment

The effects of the embodiment will be described below.

Through the above-mentioned reinforcement learning, the action value function is used for training to obtain an action value function that selects an action to maximize a value of a future action. Since a value of an action related to redeployment of vehicles between a plurality of ports is estimated based on such an action value function, and a control operation is performed so that an action that maximizes a value of a future action is selected, it is possible to optimize redeployment of vehicles to maximize a reward in reinforcement learning in redeployment of vehicles between a plurality of ports in a shared transportation service.

Specifically, since “deployment”, “collection”, and “battery replacement” are assumed as actions related to redeployment of bicycles shared in the shared transportation service, and appropriate reinforcement learning is performed based on evaluation values in a plurality of aspects such as deployment, collection, and battery replacement, vehicle redeployment is more appropriately optimized, and a reward can be maximized.

Bicycles shared in the shared transportation service are bicycles having advertisements displayed on bodies, and the learning and inference unit 12 computes the deployment evaluation value and the collection evaluation value taking into account an impression, which is the number of times that an advertisement is viewable, so that a reward from advertising can be maximized.

Even though rental electric bicycles have been illustrated as vehicles shared in the shared transportation service, it is sufficient to use any vehicle that can be restarted by replacing a battery and has an advertisement on a body, and the disclosure can be applied to other types of vehicles such as rental electric kick scooters, rental motorbikes, and rental cars. In this way, the disclosure can be applied to a wide range of vehicles including rental electric kick scooters, which have become popular in recent years, and has the potential to be widely used by users.

In addition, in the action inference stage, by executing processing of FIG. 14, an action that maximizes an action value can be selected as an action to be taken, and as a result, a reward (profit) in the service can be maximized.

Note that the embodiment is an example of the disclosure, and a type of information, content of a reward, content of processing, etc. are not limited to those described above.

The gist of the disclosure lies in the following [1] to [5].
[1] An information processing device including an acquisition unit configured to acquire information input to an action value function for estimating a value of an action related to redeployment of a vehicle between a plurality of ports in a shared transportation service in which the vehicle is shared, and
a learning and inference unit configured to perform reinforcement learning with respect to the action value function using the information acquired by the acquisition unit to obtain the action value function for selecting an action maximizing a future action value.
[2] The information processing device according to [1], wherein
the vehicle shared in the shared transportation service is a vehicle reusable by replacement of an installed battery,
the action related to redeployment of the vehicle includes redeployment of a vehicle to a port, collection of a vehicle from a port, and replacement of the battery mounted on the vehicle, and
the learning and inference unit computes a deployment evaluation value related to the redeployment, a collection evaluation value related to the collection, and a battery replacement evaluation value related to the battery replacement for each port using a predetermined computation formula as a reward included in the value of the action, and performs the reinforcement learning based on deployment evaluation values, collection evaluation values, and battery replacement evaluation values obtained for all ports.
[3] The information processing device according to [2], wherein
the vehicle shared in the shared transportation service is a vehicle having an advertisement displayed on a body, and
the learning and inference unit computes the deployment evaluation value and the collection evaluation value using impressions, which are the number of times that an advertisement is viewable, as an element.
[4] The information processing device according to [3], wherein the vehicle shared in the shared transportation service is each of a rental electric bicycle, a rental electric kick scooter, a rental motorbike, and a rental car allowed to be restarted by battery replacement and having an advertisement on the body.
[5] The information processing device according to any one of [1] to [4], wherein, in an action inference stage, the learning and inference unit substitutes state information at a current time point acquired by the acquisition unit into the action value function obtained by the reinforcement learning to acquire an action value when each of various actions is performed in a state at the current time point, and selects the action maximizing the acquired action value as an action to be taken.

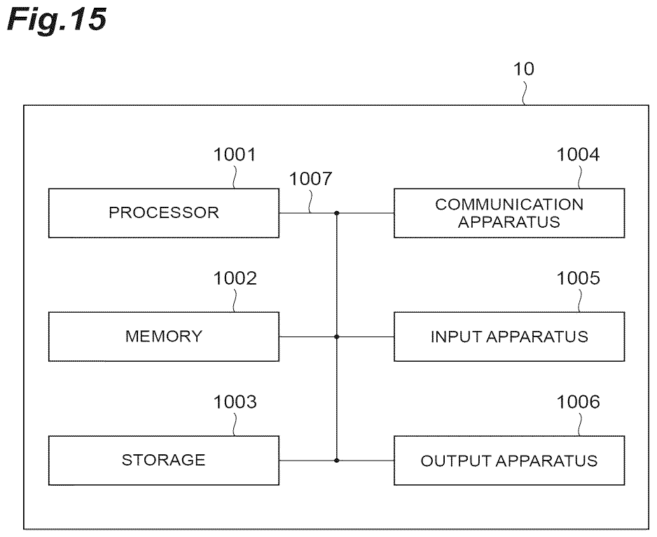

### (Description of Terms, Description of Hardware Configuration (FIG. 15), etc.)

Note that the block diagrams used in the description of the embodiment illustrate functional blocks. These functional blocks (components) are realized by any combination of at least one of hardware and software. In addition, a method of realizing each functional block is not particularly limited. That is, each functional block may be realized using one apparatus that is physically or logically combined, or may be realized by directly or indirectly (e.g., using wires, wirelessly, etc.) connecting two or more physically or logically separated apparatuses and using a plurality of these apparatuses. The functional block may be realized by combining the one apparatus or the plurality of apparatuses with software.

Examples of functions include determining, judging, calculating, computing, processing, deriving, investigating, looking up, ascertaining, receiving, transmitting, output, accessing, resolving, selecting, establishing, comparing, assuming, expecting, considering, broadcasting, notifying, communicating, forwarding, configuring, reconfiguring, allocating, mapping, assigning, etc. However, the disclosure is not limited thereto. For example, a functional block (component) that performs a transmission function is referred to as a transmitting unit or a transmitter. In either case, as mentioned above, a realization method is not particularly limited.

For example, the information processing device according to the embodiment of the disclosure may function as a computer that executes processing of the disclosure. FIG. 15 is a diagram illustrating an example of a hardware configuration of the information processing device 10 according to the embodiment of the disclosure. The above-mentioned information processing device 10 may be physically configured as a computer apparatus including a processor 1001, a memory 1002, a storage 1003, a communication apparatus 1004, an input apparatus 1005, an output apparatus 1006, a bus 1007, etc.

Note that, in the following description, the term “apparatus” may be replaced with a circuit, an apparatus, a unit, etc. In the hardware configuration of the information processing device 10, each apparatus illustrated in the figure may be included as one apparatus or a plurality of apparatuses, and some apparatuses may be excluded.

Each function in the information processing device 10 is realized by loading a specific software (program) onto hardware such as the processor 1001 and the memory 1002, so that the processor 1001 performs calculation, controls communication via the communication apparatus 1004, and controls at least one of reading and writing of data in the memory 1002 and the storage 1003.

For example, the processor 1001 operates an operating system to control the entire computer. The processor 1001 may include a CPU (Central Processing Unit) having an interface with respect to a peripheral apparatus, a control apparatus, an arithmetic apparatus, a register, etc.

Furthermore, the processor 1001 reads a program (program code), a software module, data, etc. from at least one of the storage 1003 and the communication apparatus 1004 into the memory 1002, and executes various processes according to the program (program code), the software module, the data, etc. A program that causes a computer to execute at least some of the operations described in the embodiment is used as the program. Even the various processes have been described as being executed by one processor 1001, the processes may be may be simultaneously or sequentially executed by two or more processors 1001. The processor 1001 may be implemented by one or more chips. Note that the program may be transmitted from a network via a telecommunications line.

The memory 1002 is a computer-readable recording medium, and may include, for example, at least one of a ROM (Read Only Memory), an EPROM (Erasable Programmable ROM), an EEPROM (Electrically Erasable Programmable ROM), a RAM (Random Access Memory), etc. The memory 1002 may be referred to as a register, a cache, a main memory (main memory apparatus), etc. The memory 1002 can store a program (program code), a software module, etc. that can be executed to implement a wireless communication method according to an embodiment of the disclosure.

The storage 1003 is a computer-readable recording medium, and may include, for example, at least one of an optical disc such as a CD-ROM (Compact Disc ROM), a hard disk drive, a flexible disk, a magneto-optical disc (e.g., a compact disk, a digital versatile disk, and a Blu-ray (registered trademark) disk), a smart card, a flash memory (e.g., a card, a stick, and a key drive), a floppy (registered trademark) disk, a magnetic strip, etc. The storage 1003 may be referred to as an auxiliary storage apparatus. The above-mentioned storage medium may be, for example, a database, a server, or other suitable media including at least one of the memory 1002 and the storage 1003.

The communication apparatus 1004 is hardware (transmission/reception device) for communication between computers via at least one of a wired network and a wireless network, and is also referred to as, for example, a network device, a network controller, a network card, a communication module, etc. The communication apparatus 1004 may include a high-frequency switch, a duplexer, a filter, a frequency synthesizer, etc., in order to realize, for example, at least one of FDD (Frequency Division Duplex) and TDD (Time Division Duplex).

The input apparatus 1005 is an input device (e.g., a keyboard, a mouse, a microphone, a switch, a button, a sensor, etc.) that receives input from the outside. The output apparatus 1006 is an output device (e.g., a display, a speaker, an LED lamp, etc.) that performs output to the outside. Note that the input apparatus 1005 and the output apparatus 1006 may be integrated into one configuration (e.g., a touch panel).

Furthermore, each apparatus, such as the processor 1001 or the memory 1002, is connected by the bus 1007 for communicating information. The bus 1007 may be configured using a single bus, or may be configured using a different bus for each apparatus.

In addition, the information processing device 10 may include hardware such as a microprocessor, a digital signal processor (DSP), an application specific integrated circuit (ASIC), a programmable logic apparatus (PLD), or a field programmable gate array (FPGA), and some or all of the functional blocks may be realized by the hardware. For example, the processor 1001 may be implemented using at least one of these pieces of hardware.

Notification of information is not limited to the aspect/embodiment described in the disclosure, and may be performed using other methods. For example, notification of information may be performed by physical layer signaling (e.g., DCI (Downlink Control Information), UCI (Uplink Control Information)), higher-layer signaling (e.g., RRC (Radio Resource Control) signaling, MAC (Medium Access Control) signaling, broadcast information (MIB (Master Information Block), and an SIB (System Information Block)), other signals, or a combination thereof. In addition, the RRC signaling may be referred to as an RRC message, and may be, for example, an RRC Connection Setup message, an RRC Connection Reconfiguration message, etc.

Each aspect/embodiment described in the disclosure may be applied to at least one of a system using LTE (Long Term Evolution), LTE-A (LTE-Advanced), SUPER 3G, IMT-Advanced, 4G (4th generation mobile communication system), 5G (5th generation mobile communication system), 6th generation mobile communication system (6G), xth generation mobile communication system (xG) (e.g. x is an integer or a decimal), FRA (Future Radio Access), NR (new Radio), New radio access (NX), Future generation radio access (FX), W-CDMA (registered trademark), GSM (registered trademark), CDMA2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), and other appropriate systems, and a next-generation system expanded, modified, created, or defined based thereon. In addition, each aspect/embodiment may be applied by combining a plurality of systems (e.g., a combination of at least one of LTE and LTE-A with 5G, etc.).

The order of the processing procedures, sequences, flowcharts, etc. of each aspect/embodiment described in the disclosure may be changed unless there is inconsistency. For example, with regard to the methods described in the disclosure, elements of various steps are presented using example orders, and the methods are not limited to the presented particular orders.

The input and output information may be stored in a specific location (e.g., memory) or may be managed using a management table. The input and output information may be overwritten, updated, or added. The output information, etc. may be deleted. The input information, etc. may be transmitted to another apparatus.

Judging may be performed based on a value represented by 1 bit (0 or 1), performed based on a Boolean value (true or false), or performed based on numerical comparison (e.g., comparison with a predetermined value).

Each aspect/embodiment described in the disclosure may be used alone, in combination, or by being switched according to execution. In addition, notification of predetermined information (e.g., notification that “X is true”) is not limited to being done explicitly, but may be done implicitly (e.g., not notifying the predetermined information).

Even though the disclosure has been described in detail above, it is clear to those skilled in the art that the disclosure is not limited to the embodiment described in the disclosure. The disclosure can be implemented in modified and altered forms without departing from the spirit and scope of the disclosure as defined by the claims. Therefore, the description of the disclosure is intended to be illustrative and does not have any limiting meaning on the disclosure.

Software should be broadly construed to mean instructions, instruction sets, code, code segments, program code, programs, subprograms, software modules, applications, software applications, software packages, routines, subroutines, objects, executable files, threads of execution, procedures, functions, etc. regardless of whether the software is referred to as software, firmware, middleware, microcode, or hardware description language, or referred to as other names.

In addition, when software, instructions, information, etc. may be transmitted and received via a transmission medium. For example, when the software is transmitted from a Web site, a server, or other remote sources using at least one of wired technology (such as coaxial cable, fiber optic cable, twisted pair, or Digital Subscriber Line (DSL)), and wireless technology (such as infrared or microwave), at least one of the wired technology and the wireless technology is included in the definition of the transmission medium.

The information, signals, etc. described in the disclosure may be represented using any of a variety of different technologies. For example, the data, instructions, commands, information, signals, bits, symbols, chips, etc. that can be mentioned throughout the above description may be represented by voltages, currents, electromagnetic waves, magnetic fields or magnetic particles, optical fields, photons, or any combination thereof.

Note that the terms described in the disclosure and the terms necessary for understanding the disclosure may be replaced with terms having the same or similar meanings. For example, at least one of a channel and a symbol may be a signal (signaling). In addition, the signal may be a message. In addition, a component carrier (CC) may be referred to as a carrier frequency, a cell, a frequency carrier, etc.

As used in the disclosure, the terms “system” and “network” are interchangeably used.

In addition, the information, parameters, etc. described in the disclosure may be represented using absolute values, represented using relative values from a predetermined value, or represented using other corresponding information. For example, a radio resource may be indicated by an index.

The names used for the above-mentioned parameters are not limited in any aspect. Furthermore, the expressions etc. using these parameters may be different from those explicitly disclosed in the disclosure. The various channels (e.g., PUCCH, PDCCH, etc.) and information elements may be identified by any suitable names, and therefore the various names assigned to these various channels and information elements are not limited in any aspect.

As used in the disclosure, the term “determining” may encompass a wide variety of actions. “Determining” may include, for example, considering something subjected to judging, calculating, computing, processing, deriving, investigating, looking up (or search or inquiry) (e.g., searching in a table, a database, or other data structures), and ascertaining to be “determined”. In addition, “determining” may include, for example, considering something subjected to receiving (e.g., receiving information), transmitting (e.g., transmitting information), input, output, accessing (e.g., accessing data in a memory), etc. to be determined. In addition, “determining” may include, for example, considering something subjected to resolving, selecting, choosing, establishing, comparing, etc., to be determined. In other words, “determining” may include considering some actions to be “determined”. In addition, “determining” may be interpreted as “assuming”, “expecting”, “considering”, etc.

As used in the disclosure, the phrase “based on” does not mean “based only on,” unless expressly stated otherwise. In other words, the phrase “based on” means both “based only on” and “based at least on.”

Any reference to elements using designations such as “first,” “second,” etc., used in the disclosure does not generally limit the quantity or order of those elements. These designations may be used in the disclosure as a convenient method of distinguishing between two or more elements. Therefore, a reference to a first and a second element does not imply that only two elements may be employed or that the first element needs to precede the second element in some way.

When the terms “include,” “including,” and variations thereof are used in the disclosure, these terms are intended to be inclusive, similar to the term “comprising.” Further, as used in the disclosure, the term “or” is not intended to be an exclusive or.

In the disclosure, for example, when articles such as “a”, “an”, and “the” in English have been added by translation, the disclosure may include that nouns following these articles are in the plural form.

In the disclosure, the term “A and B are different” may mean “A and B are different from each other”. The term may also mean “A and B are each different from C”. Terms such as “separate” and “coupled” may also be interpreted similarly to “different”.

Reference Signs List

```
  10: information processing device,
  11: acquisition unit,
  12: learning and inference unit,
1001: processor,
1002: memory,
1003: storage,
1004: communication apparatus,
1005: input apparatus,
1006: output apparatus,
1007: bus.
```

1. An information processing device comprising:
an acquisition unit configured to acquire information input to an action value function for estimating a value of an action related to redeployment of a vehicle between a plurality of ports in a shared transportation service in which the vehicle is shared; and
a learning and inference unit configured to perform reinforcement learning with respect to the action value function using the information acquired by the acquisition unit to obtain the action value function for selecting an action maximizing a future action value.

2. The information processing device according to claim 1, wherein:
the vehicle shared in the shared transportation service is a vehicle reusable by replacement of an installed battery,
the action related to redeployment of the vehicle includes redeployment of a vehicle to a port, collection of a vehicle from a port, and replacement of the battery mounted on the vehicle, and
the learning and inference unit computes a deployment evaluation value related to the redeployment, a collection evaluation value related to the collection, and a battery replacement evaluation value related to the battery replacement for each port using a predetermined computation formula as a reward included in the value of the action, and performs the reinforcement learning based on deployment evaluation values, collection evaluation values, and battery replacement evaluation values obtained for all ports.

3. The information processing device according to claim 2, wherein:
the vehicle shared in the shared transportation service is a vehicle having an advertisement displayed on a body, and
the learning and inference unit computes the deployment evaluation value and the collection evaluation value using impressions, which are the number of times that an advertisement is viewable, as an element.

4. The information processing device according to claim 3, wherein the vehicle shared in the shared transportation service is each of a rental electric bicycle, a rental electric kick scooter, a rental motorbike, and a rental car allowed to be restarted by battery replacement and having an advertisement on the body.

5. The information processing device according to claim 1, wherein, in an action inference stage, the learning and inference unit substitutes state information at a current time point acquired by the acquisition unit into the action value function obtained by the reinforcement learning to acquire an action value when each of various actions is performed in a state at the current time point, and selects the action maximizing the acquired action value as an action to be taken.
